(19) United States
(12) Patent Application Publication
(10) Pub. No.: US 2012/0270014 A1
(43) Pub. Date: Oct. 25, 2012

(54) Method for Permanently Decorating Glass

(76) Inventors: Harry Michael Williams, New Hope, PA (US); John W. Crossley, Quakertown, PA (US); Jessie Alfaro, Upper Black Eddy, PA (US)

(21) Appl. No.: 13/456,207

(22) Filed: Apr. 25, 2012

Related U.S. Application Data
(60) Provisional application No. 61/478,703, filed on Apr. 25, 2011.

(51) Int. Cl. B32B 17/06; C03C 17/22

(52) U.S. Cl. 428/141; 65/60.1; 428/210

(57) ABSTRACT

A method for permanently decorating glass including the steps of applying ceramic colorants, which have a higher cure temperature than a glass workpiece, to the glass workpiece, placing the prepared glass workpiece on a textured carrier, heating the glass and carrier to about 1450 degree Fahrenheit followed by a cooling cycle, and removing the textured carrier from the glass workpiece. At about 1450 degree Fahrenheit, the higher cure temperature of the ceramic colorants causes them to sink or absorb into the softened glass workpiece and remain below its surface, resulting in a subcutaneous effect with a pleasing sense of depth. At the same time, preferably a desired texture is achieved in the workpiece as the softened glass deforms to the texture of the carrier on which it lays when heated and cooled.

### CROSS-REFERENCE TO RELATED APPLICATIONS

This application claims the benefit of priority of U.S. Provisional Patent Application No. 61/478,703, filed Apr. 25, 2011, which is hereby incorporated by reference in its entirety.

### FIELD OF THE INVENTION

The present invention relates generally to applying permanent decoration to glass, sheets of glass, and glass workpieces. More specifically, this invention relates to a novel method for permanently decorating glass so as to achieve a subcutaneous effect with a sense of depth while in the same process achieving a textured surface as desired.

### BACKGROUND OF THE INVENTION

In the fine arts and the applied arts, such as the making of home decorating objects, glass tiles and funerary urns, an artist often desires to apply a detailed, colorful decoration to a sheet of glass as with paint, ink or decals. Application of ordinary paints or decals to glass surfaces fail to adhere to glass sufficiently to resist rub-off, scratching or chipping.

Use of special ink compounds to decorate glass articles is well known. Such ink compounds typically are bonded to the glass by firing at temperatures below the softening point of the glass or, in the case of radiation cured inks, by exposure to ultraviolet light. Use of special enamels to decorate glass articles also is known. Enameling compounds used for glass typically contain a pigment component and a flux component to chemically bond to the glass during firing. However, enamels tend to crack or craze during firing due to the different thermal expansion rates of the enamel and the glass. Moreover, while special enamels and special ink compounds provide a permanent, scratch-proof coloration of the glass, the effect is two-dimensional and flat such that the color appears upon the surface of the glass and offers no sense of depth.

Use of decals to decorate glass objects is known in the art. However, application of a decal label to a glass article requires special treatment of the label and the object to ensure the decal is recessed into the glass and is covered with a special coating to protect it from scratches and wear. See, for example, U.S. Pat. No. 1,646,468.

Ceramic colorants are well-known for the purpose of glazing ceramics. Ceramic colorants typically have a cure temperature of about 1450 degree Fahrenheit to about 1575 degree Fahrenheit. Typically, ceramic colorants are not used on glass because the working temperature of the ceramic colorants exceeds that of the softening point of the glass. Therefore, the glass article becomes misshapen before or upon reaching the necessary temperature to cure the colorants. Enamels may be applied to the surface of glass workpieces and fired at a range of about 1100 degree Fahrenheit to about 1300 degree Fahrenheit resulting in a surface decoration that has no sense of depth and that is prone to crazing, cracking or chipping.

Various techniques are known to achieve a textured surface on a sheet of glass or glass article, including slumping, molding, forming and manipulation with hand tools while hot, sandblasting, chemical texturing (i.e. frosting), and cold working such as diamond cutting. These techniques require an additional set of steps to apply the texture to the glass either before or after the colored decoration is achieved, and some require additional firing in a kiln or furnace.

Therefore, there is a need in the art for a simple and efficient method of achieving a permanent, wear-proof colored decoration of glass with a sense of depth and texture. It is the object of the present invention to provide a simple and efficient method for permanently decorating glass that offers a sense of depth and texture. It is a further object of the present invention to provide a simple and efficient method to apply decals to sheet glass so as to achieve a permanent, wear-proof result with a sense of depth and texture. It is a further object of the present invention to provide a method whereby fine art representations may be reproduced on glass.

### SUMMARY OF THE INVENTION

The present invention is directed to a method for permanently decorating glass. In one embodiment, the method for permanently decorating glass comprises the steps of:
(a) applying ceramic colorants to the surface of a glass workpiece, such as a sheet or flat piece of glass, of which some non-limiting examples are opaque glass or clad glass, with a softening point of about 1100 degree Fahrenheit to about 1300 degree Fahrenheit;
(b) allowing the prepared glass to dry;
(c) applying a textured carrier, such as a ceramic fiber paper or an alumina fiber board, with the desired texture to the carrier surface of a firing device, such as a kiln or lehr;
(d) placing the prepared glass face up on the textured carrier and placing the textured carrier and glass in the firing device;
(e) firing the prepared glass in the firing device in a cycle with a top temperature of about 1450 degree Fahrenheit followed by immediate shut down and cooling;
(f) allowing the firing device and its contents to cool for 8 hours; and
(g) removing the prepared glass from the firing device and removing the remaining component, such as the paper component of a ceramic fiber paper, of the textured carrier from the back of the glass.
   Suitable glasses include glasses preferably with a softening temperature in the range of from about 1100 degree Fahrenheit to about 1300 degree Fahrenheit, such as soda-lime glass, lead glass, opaque glass, and clad glass. Ceramic colorants having a higher cure temperature (about 1450 degree Fahrenheit to about 1575 degree Fahrenheit) than that of the glass include powdered ceramic colorants mixed with a fluxing agent and dispersed in liquid medium such as oil, alcohol or water. Because the ceramic colorants have a higher firing temperature range than the sheet glass, the glass softens before the colors mature, causing the colorants to sink into the surface of the glass and produce a subcutaneous effect. The texture is achieved as the softened glass is deformed by the texture of the carrier during the firing process. In this way, a single firing imparts to the finished piece both the subcutaneous colored decoration and the textured surface.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a diagram depicting the steps of two embodiments of the invention;

FIG. 2 is a photograph of an image printed with ceramic toner on ceramic decal paper;

FIG. 3 is a photograph of a cut, cleaned and dried glass workpiece of the invention;

FIG. 4 is a photograph of the ceramic toner decal being loosened from its backing paper;

FIG. 5 is a photograph of the ceramic toner decal being applied to the workpiece;

FIG. 6 is a photograph of the paper backing being removed from the ceramic toner decal;

FIG. 7 is a photograph of the ceramic toner decal being adjusted on the workpiece;

FIG. 8 is a photograph of excess water and air bubbles being removed from the ceramic toner decal and workpiece;

FIG. 9 is a photograph of the workpiece being placed face up on the ceramic fiber paper on the kiln shelf; and

FIG. 10 is a photograph of the kiln shelf being placed in the kiln for firing.

### DETAILED DESCRIPTION OF THE INVENTION

The present invention is directed to a method for permanently decorating glass. In one embodiment, the method for permanently decorating glass comprises the steps of:
(a) applying ceramic colorants to the surface of a glass workpiece, such as a sheet or flat piece of glass, of which some non-limiting examples are opaque glass or clad glass, with a softening point of about 1100 degree Fahrenheit to about 1300 degree Fahrenheit;
(b) allowing the prepared glass to dry;
(c) applying a textured carrier, such as a ceramic fiber paper or an alumina fiber board, with the desired texture to the carrier surface of a firing device, such as a kiln or lehr;
(d) placing the prepared glass face up on the textured carrier and placing the textured carrier and glass in the firing device;
(e) firing the prepared glass in the firing device in a cycle with a top temperature of about 1450 degree Fahrenheit followed by immediate shut down and cooling;
(f) allowing the firing device and its contents to cool for 8 hours; and
(g) removing the prepared glass from the firing device and removing the remaining component, such as the paper component of a ceramic fiber paper, of the textured carrier from the back of the glass.

Preferably, the present invention uses ceramic colorants applied to an up-facing side of a glass sheet. Suitable glasses include glasses preferably with a softening temperature in the range of from about 1100 degree Fahrenheit to about 1300 degree Fahrenheit, such as soda-lime glass, lead glass, opaque glass, and clad glass. When fired in a kiln or lehr above the softening temperature of the glass, the ceramic colorants sink below the surface of the glass, resulting in a unique subcutaneous, underwater effect when finished. At the same time, in the same kiln or lehr cycle, the down-facing side of the softened glass adopts a desired texture from a pre-selected textured carrier, such as ceramic fiber paper, placed between the glass workpiece or sheet and the kiln shelf or lehr belt.

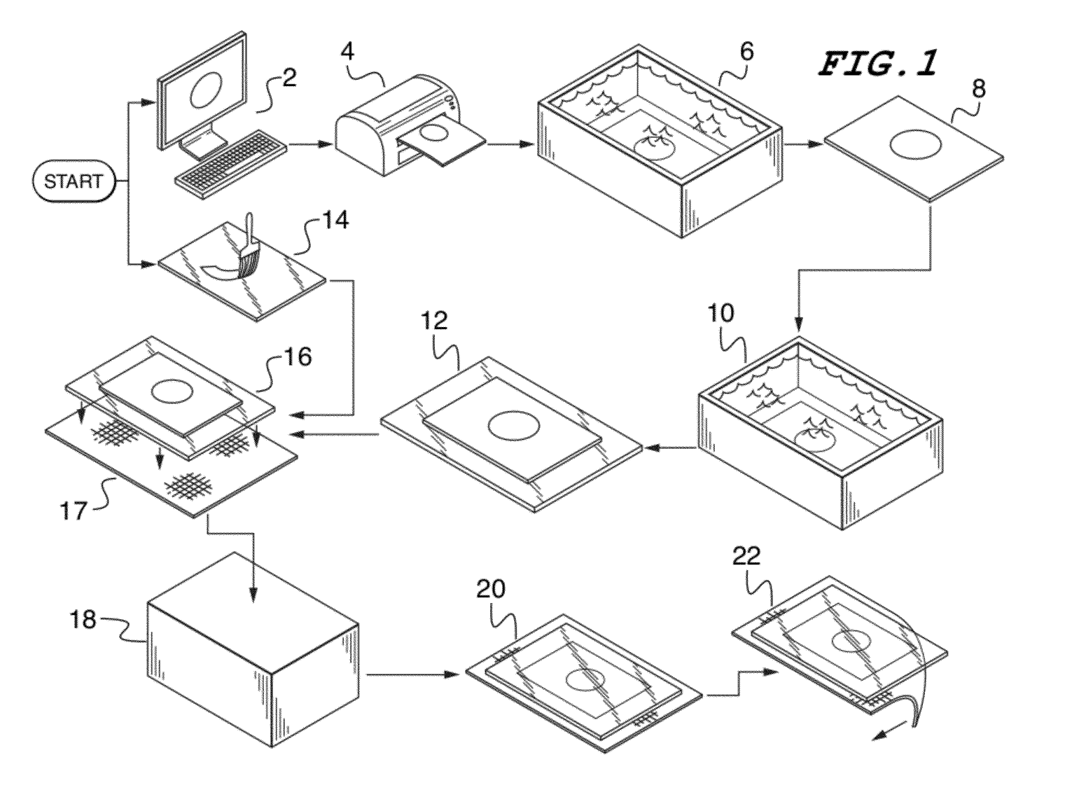

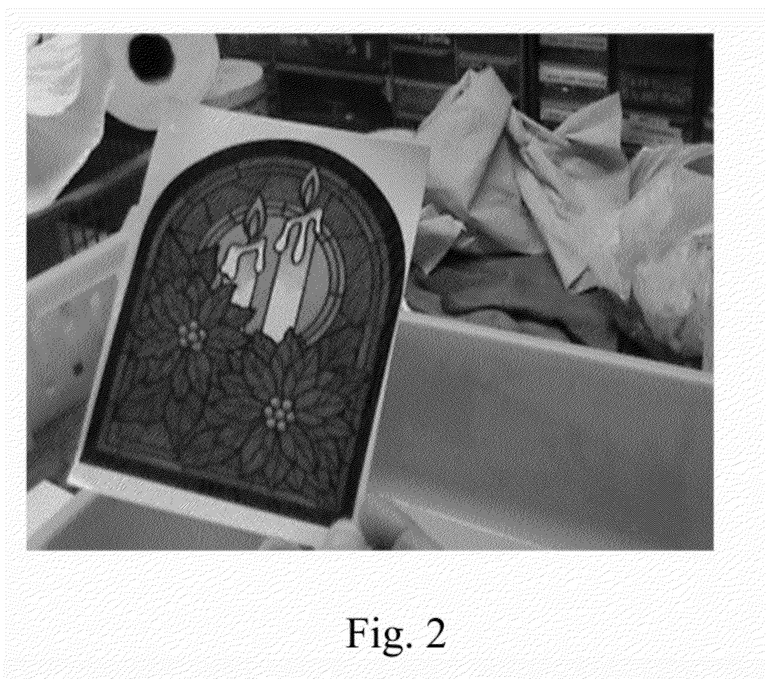

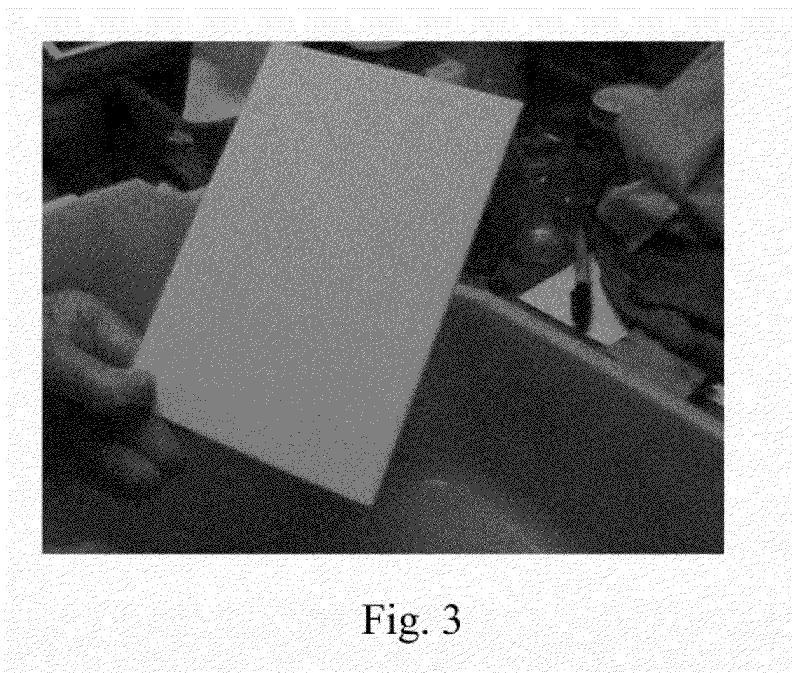

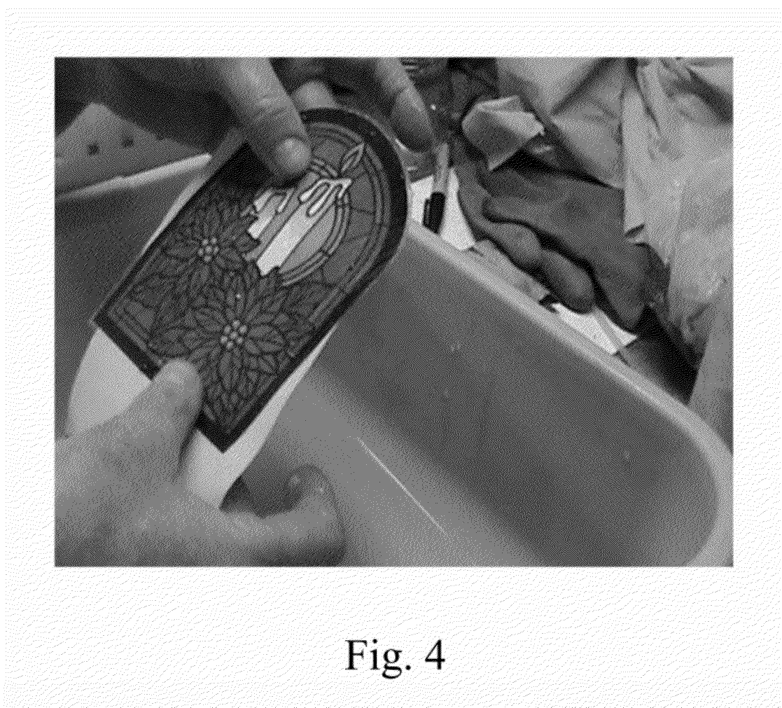

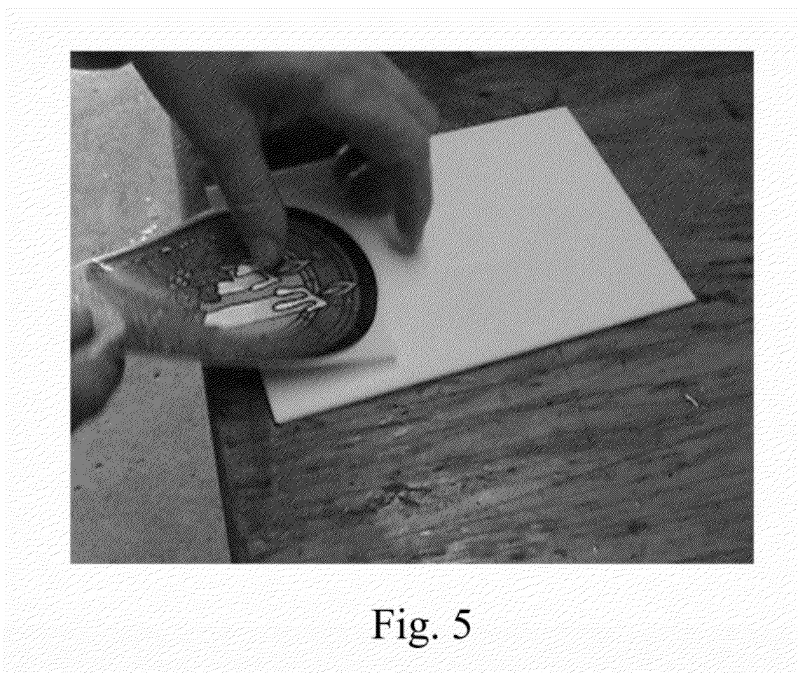

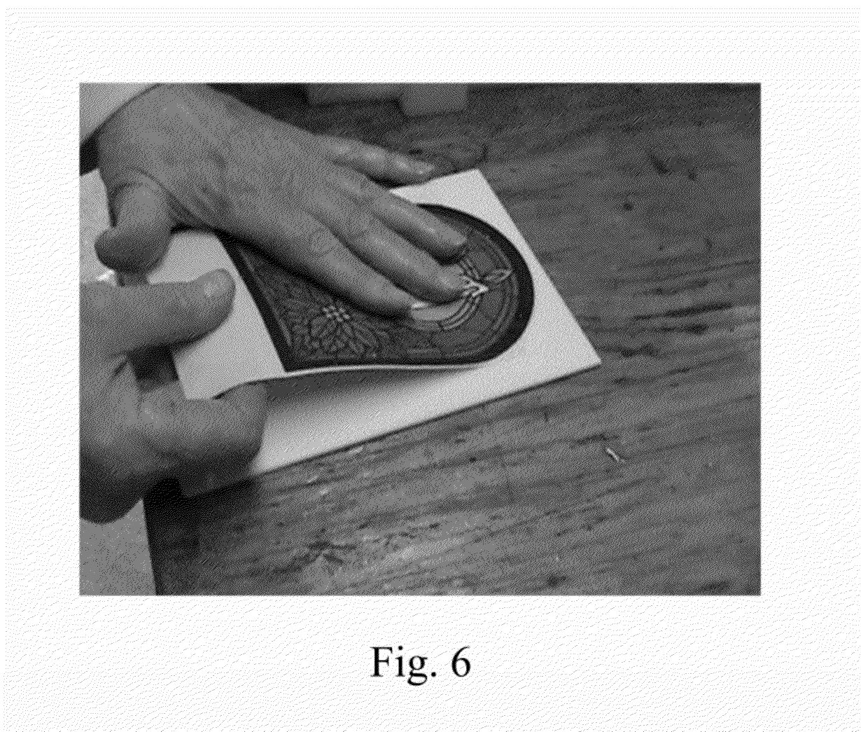

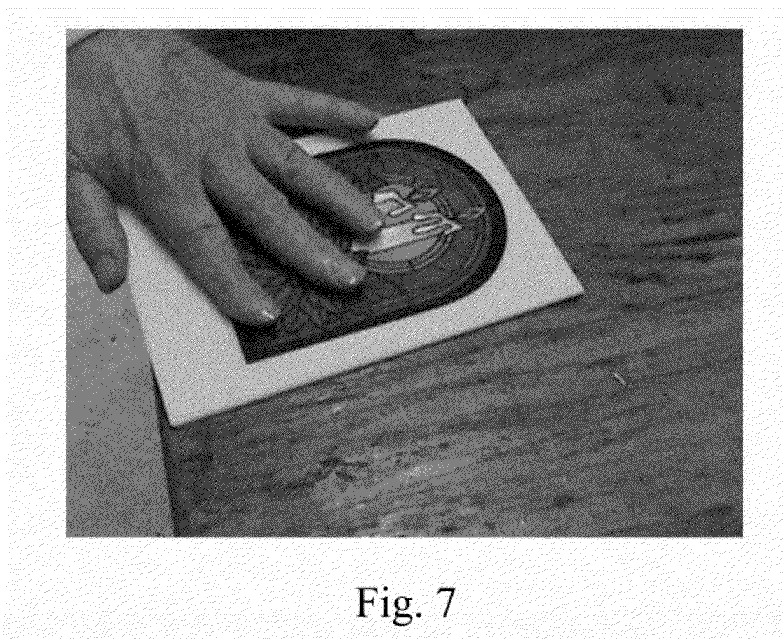

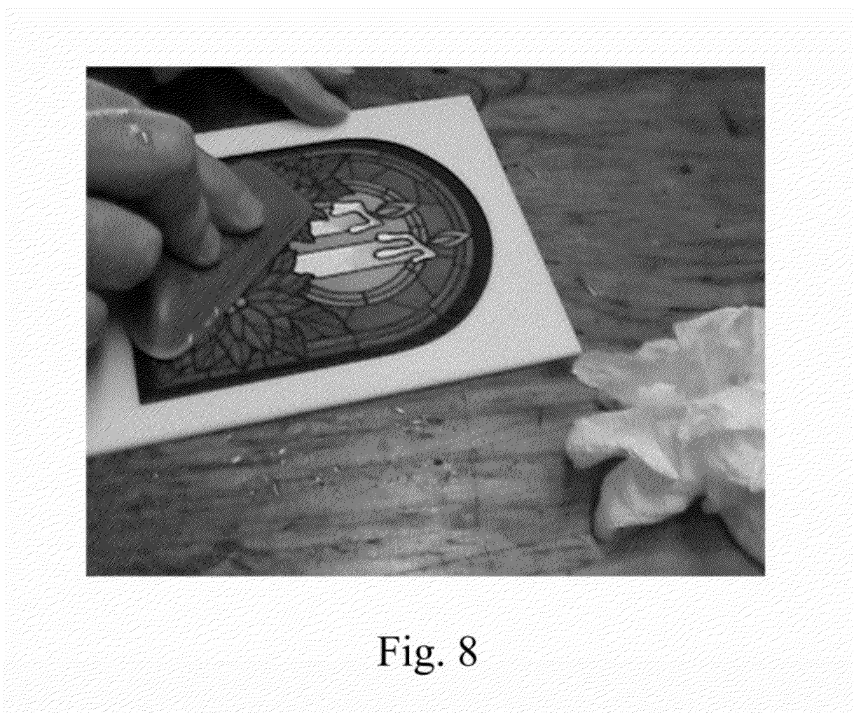

In one embodiment of the invention, as shown in FIG. 1, a ceramic toner decal is created by scanning an image to a computer, 2, sending the image to a printer with cartridges containing ceramic toner, printing the image on ceramic decal paper, 4 (and FIG. 2), and coating the printed ceramic decal paper with laminate to create a water slide decal, 6, and the decal is left to dry, 8. Suitable glass is selected, cut to size, cleaned and dried, creating a glass workpiece, (FIG. 3). Opaque soda-lime sheet glass, such as white opal fusable glass, is a suitable choice. Once dry, the laminated water slide decal is placed in water for several minutes, 10, and the decal is loosened but not yet removed from the paper backing (FIG. 4.) The wet decal is applied to the cut, cleaned and dried glass workpiece (FIG. 5), as the decal's paper backing is removed (FIG. 6), and the decal's position is adjusted on the glass workpiece until the desired position is reached 12 (and FIG. 7). Excess water and air bubbles are removed from the glass workpiece (FIG. 8). The glass workpiece with the decal applied is allowed to dry for 8 hours.

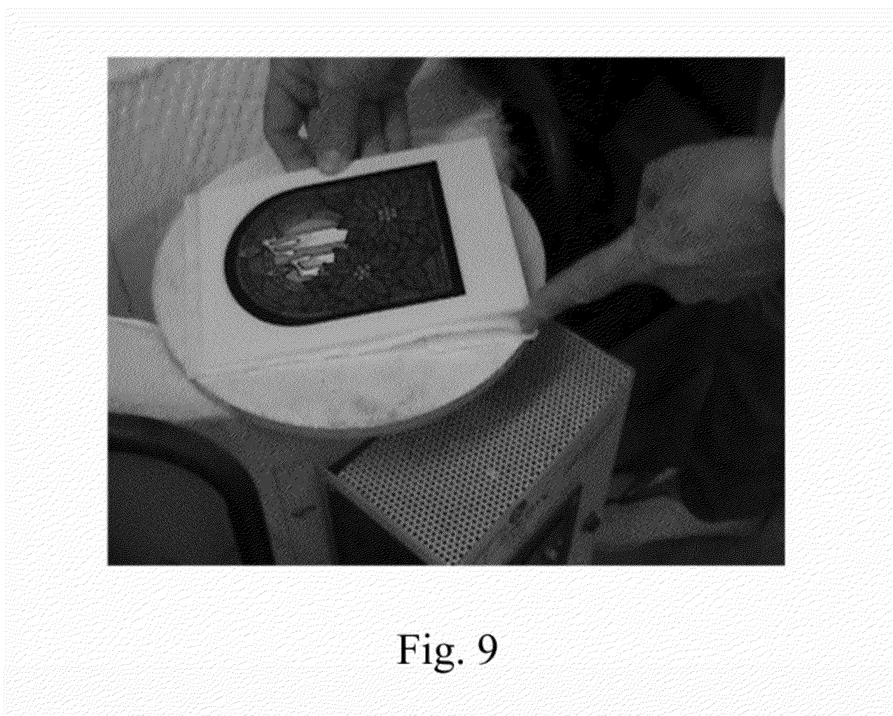

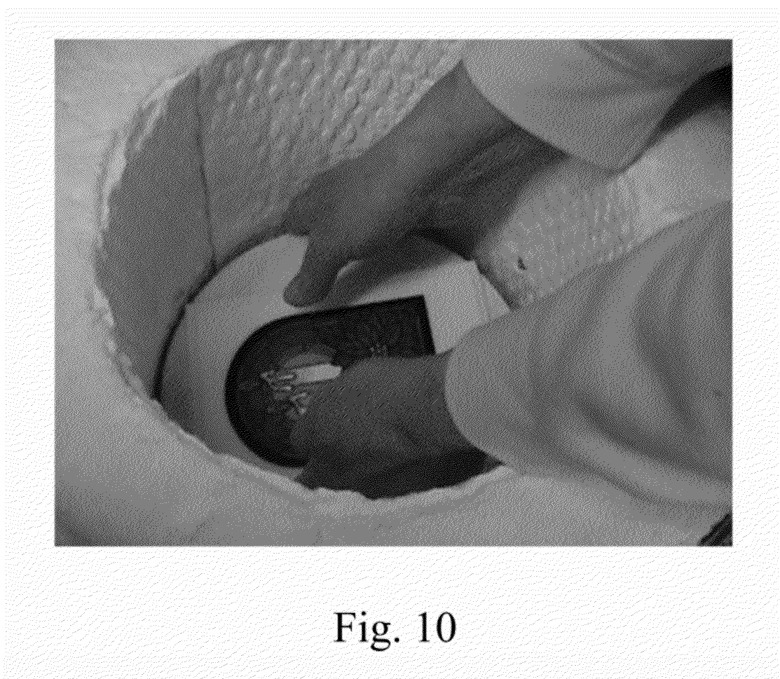

Ceramic fiber paper with the desired texture is selected and cut to the size of the glass or slightly larger, forming a carrier, 17, to be placed between the glass workpiece and the kiln shelf or lehr belt. One suitable selection is Fiberfrax® brand ceramic fiber paper. The ceramic fiber paper is placed on the kiln shelf or lehr belt and the glass workpiece is placed face up, 16, on the ceramic fiber paper (FIG. 9). The kiln shelf or lehr belt with the paper and workpiece are placed in the kiln, 18 (and FIG. 10). The kiln or lehr is adjusted to a cycle with a maximum temperature of 1450 degree Fahrenheit followed by a cooling cycle. One or more kiln cones may be used to ensure the proper maximum temperature is reached. As the softening point of the glass workpiece is reached and exceeded, the weight of the softened workpiece pressing against the textured carrier causes the bottom surface of the workpiece to deform to the texture of the textured carrier, while the still-uncured ceramic colorants on the top surface of the workpiece sink below the surface of the softened workpiece, where they cure upon reaching the maximum temperature of the firing cycle. As the glass workpiece anneals, the now-cured ceramic colorants remain below the surface of the glass, resulting in the subcutaneous, “underwater” effect of the finished workpiece. After about 8 hours of cooling, 20, the textured carrier is separated from the workpiece, 22, and discarded.

In other embodiments of the invention, as shown on FIG. 1, a workpiece of suitable glass is cut, cleaned and dried; ceramic colorants are applied to the workpiece using brushes, sponges, rollers, spraying, screenprinting or block printing, 14; the workpiece is allowed to dry, 12, then is placed 16, on a textured carrier, 17, such as a sheet of ceramic fiber paper or alumina fiber board, with a desired texture; and the workpiece and carrier are fired, 18, allowed to cool, 20, and separated, 22, as previously described. In a further embodiment of the invention, a workpiece of suitable glass is cut, cleaned, dried and placed on a textured carrier with a desired texture; powdered ceramic colorants are applied to the workpiece dry in a single or a plurality of layers, forming a design; and the workpiece and carrier are fired as previously described. In a further embodiment of the invention, a workpiece of suitable glass is cut, cleaned, dried and placed on a textured carrier with a desired texture; powdered ceramic colorants are mixed with water and applied to the workpiece in a single or a plurality of layers, forming a design; and the workpiece and carrier are fired as previously described. In a further embodiment of the invention, a workpiece of suitable glass is cut, cleaned, dried; ceramic colorants are applied to the workpiece in a single or a plurality of layers, forming a design; the workpiece is placed on a textured carrier comprising a single or plurality of ceramic or metal trays, molds or articles that have been coated with a compound that prevents the workpiece from permanently adhering to the carrier during firing and cooling; and the workpiece and carrier are fired as previously described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for permanently decorating glass comprising the steps of:
applying ceramic colorant to a glass workpiece, wherein the glass workpiece has a softening point and comprises a first surface and an inner layer, and wherein the first surface is in contact with the ceramic colorant;
allowing the applied ceramic colorant to dry;
heating a firing device, containing the glass workpiece and the applied ceramic colorant after the drying step, to a heating temperature above the softening point of the glass workpiece whereby causing the applied ceramic colorant to be at least partially absorbed into the inner layer of the glass workpiece; and
allowing the glass workpiece from the heating step to cool down.

2. The method for permanently decorating glass according to claim 1, wherein the glass workpiece is comprised of glass material selected from the group consisting of soda-lime glass, lead glass, opaque glass, clad glass, and any combination thereof.

3. The method for permanently decorating glass according to claim 1, wherein the glass workpiece further comprises a second surface, and wherein the second surface is in contact with a textured carrier during the heating step whereby textured effects of the textured carrier is transferred onto the second surface of the glass workpiece.

4. The method for permanently decorating glass according to claim 3, wherein the textured carrier is selected from the group consisting of a ceramic fiber paper and an alumina fiber board.

5. The method for permanently decorating glass according to claim 1, wherein the ceramic colorant is included with an image.

6. The method for permanently decorating glass according to claim 1, wherein the ceramic colorant is included with an image decal.

7. The method for permanently decorating glass according to claim 1, wherein the heating temperature above the softening point of the glass workpiece is about 1450 degree Fahrenheit.

8. The method for permanently decorating glass according to claim 1, whereby causing the applied ceramic colorant to be at least substantially absorbed into the inner layer of the glass workpiece.

9. The method for permanently decorating glass according to claim 1, wherein the softening point of the glass workpiece is in the range of from about 1100 degree Fahrenheit to about 1300 degree Fahrenheit.

10. The method for permanently decorating glass according to claim 9, wherein the glass workpiece is comprised of glass material selected from the group consisting of soda-lime glass, lead glass, opaque glass, clad glass, and any combination thereof.

11. The method for permanently decorating glass according to claim 9, wherein the glass workpiece further comprises a second surface, and wherein the second surface is in contact with a textured carrier during the heating step whereby textured effects of the textured carrier is transferred onto the second surface of the glass workpiece.

12. The method for permanently decorating glass according to claim 11, wherein the textured carrier is selected from the group consisting of a ceramic fiber paper and an alumina fiber board.

13. The method for permanently decorating glass according to claim 9, wherein the ceramic colorant is included with an image.

14. The method for permanently decorating glass according to claim 9, wherein the ceramic colorant is included with an image decal.

15. The method for permanently decorating glass according to claim 9, wherein the heating temperature above the softening point of the glass workpiece is about 1450 degree Fahrenheit.

16. The method for permanently decorating glass according to claim 9, whereby causing the applied ceramic colorant to be at least substantially absorbed into the inner layer of the glass workpiece.

17. A permanently decorated glass workpiece comprising a glass workpiece, wherein said glass workpiece comprises a first surface and an inner layer, and wherein said inner layer comprises applied ceramic colorant.

18. The permanently decorated glass workpiece according to claim 17, wherein said glass workpiece is comprised of glass material selected from the group consisting of soda-lime glass, lead glass, opaque glass, clad glass, and any combination thereof.

19. The permanently decorated glass workpiece according to claim 17, wherein said glass workpiece has a softening point in the range of from about 1100 degree Fahrenheit to about 1300 degree Fahrenheit.

20. The permanently decorated glass workpiece according to claim 17, further comprising a second surface, wherein said second surface comprises textured effects of applied textured carrier.
